(19) United States
(12) Patent Application Publication
(10) Pub. No.: US 2026/0260213 A1
(43) Pub. Date: Sep. 3, 2026

(54) RECEPTACLE SYSTEM USING REAL-TIME LARGE LANGUAGE MODEL INTEGRATION TO PREDICT A STATE OF THE RECEPTACLE SYSTEM

(71) Applicant: Maplebear Inc., San Francisco, CA (US)

(72) Inventors: Kaushik Gopal, Oakland, CA (US); Stephanie Wang, Elmhurst, NY (US); Ting Ding, Aurora (CA)

(21) Appl. No.: 19/069,121

(22) Filed: Mar. 3, 2025

(51) Int. Cl. G06Q 10/0875; G06F 40/40

(52) U.S. Cl. CPC G06Q 10/0875; G06F 40/40

(57) ABSTRACT

A system performs inference in conjunction with a machine-learned language model to predict a state of a receptacle that is located at a physical location and has sensors attached to the receptacle. The predicted state of the receptacle includes a predicted list of objects that are in a storage area of the receptacle, for example. The system may generate a first predicted state of the receptacle from receptacle sensor data of the sensors. A rule-based model may be used to generate the first predicted state, for example. The machine-learned language model may be used in conjunction with the rule-based model to also predict the state of the receptacle. The machine-learned language model better understands complex user behavior compared to the rule-based model resulting in increased accuracy of the predictions.

### BACKGROUND

Automated checkout systems allow a user at a location to complete a checkout process for objects at the location without having to interact with an individual associated with the location. These systems may allow users to complete a checkout process through a receptacle that a user uses to carry items.

Existing automated checkout systems may have computer vision models that are used to automatically identify objects added to a receptacle. However, these computer vision models are unable to interpret complex user interactions with the receptacle. For example, existing automated checkout systems often fail to identify objects that are added quickly (creating blurred images) to the receptacle and misinterpret shuffling of objects that are already within the receptacle as the addition of new objects to the receptacle. Due to the inability to interpret complex user interactions with the receptacle, existing automated checkout systems cannot accurately identify the objects in the receptacle thereby preventing the checkout process.

### SUMMARY

In accordance with one or more aspects of the disclosure, a system performs inference in conjunction with a machine-learned language model to predict a state of a receptacle that is located at a physical location. The predicted state of the receptacle includes a predicted list of objects that are in a storage area of the receptacle, for example. The system uses a combination of sensors on the receptacle and the machine-learned language model to predict the contents of the receptacle as objects interact with the receptacle.

The system receives receptacle sensor data from the sensors on the receptacle. The receptacle sensor data describes user actions with respect to a set of objects and the receptacle that are detected by the sensors. The sensors may include cameras and load sensors, for example. The system may generate a first predicted state of the receptacle from the receptacle sensor data. A rule-based model may be used to generate the first predicted state of the receptacle by applying the receptacle sensor data to the rule-based model. The rule-based model determines a set of actions that correspond to the receptacle sensor data and determines the objects that are in the receptacle from the set of actions that took place with respect to the receptacle.

In some embodiments, a machine-learned language model may be used in conjunction with the rule-based model to predict the state of the receptacle. Due to the rule-based model's reliance on pre-stored rules to predict the state of the receptacle, the rule-based model may be unable to resolve a portion of the receptacle sensor data into an action taken with respect to the receptacle. For example, the rule-based model may be unable to interpret receptacle sensor data that is associated with a complex interaction with the receptacle such as the reshuffling of objects within the receptacle. As a result, the accuracy of the predicted state of the receptacle output by the rule-based model is uncertain.

The machine-learned language model may supplement the rule-based model to predict the state of the receptacle as the machine-learned language model is better equipped to understand user behavior such as complex user interactions with the receptacle. In some embodiments, the machine-learned language model may replace the rule-based model. The machine-learned language model may generate an output that is parsed by the system to extract the predicted state of the receptacle. The system may also extract from the output an action that corresponds to a portion of the receptacle sensor data that is indicative of a complex user interaction. Thus, the usage of the machine-learned language model provides more accurate predictions of the state of the receptacle compared to if the rule-based model was utilized on its own without the machine-learned language model.

### BRIEF DESCRIPTION OF DRAWINGS

FIG. 1 illustrates an example environment of a smart receptacle system, in accordance with one or more illustrative embodiments.

FIG. 2 illustrates a high-level block diagram of a system architecture for a remote system, in accordance with one or more embodiments.

FIG. 3A is a high-level diagram of a process for applying a rule-based model to cart sensor data to predict a state of the shopping cart, in accordance with one or more example embodiments.

FIG. 3B is a high-level diagram for applying a large language model that supplements the rule-based model to the cart sensor data to predict a state of the shopping cart, in accordance with one or more example embodiments.

FIG. 4 is a high-level diagram for applying a large language model to cart sensor data to predict a state of the shopping cart, in accordance with one or more example embodiments.

FIGS. 5A, 5B, 5C, and 5D are example user interfaces that present the predicted state of the shopping cart, in accordance with one or more embodiments.

FIG. 6 is a flowchart describing prediction of a state of the shopping cart, in accordance with one or more embodiments.

### DETAILED DESCRIPTION

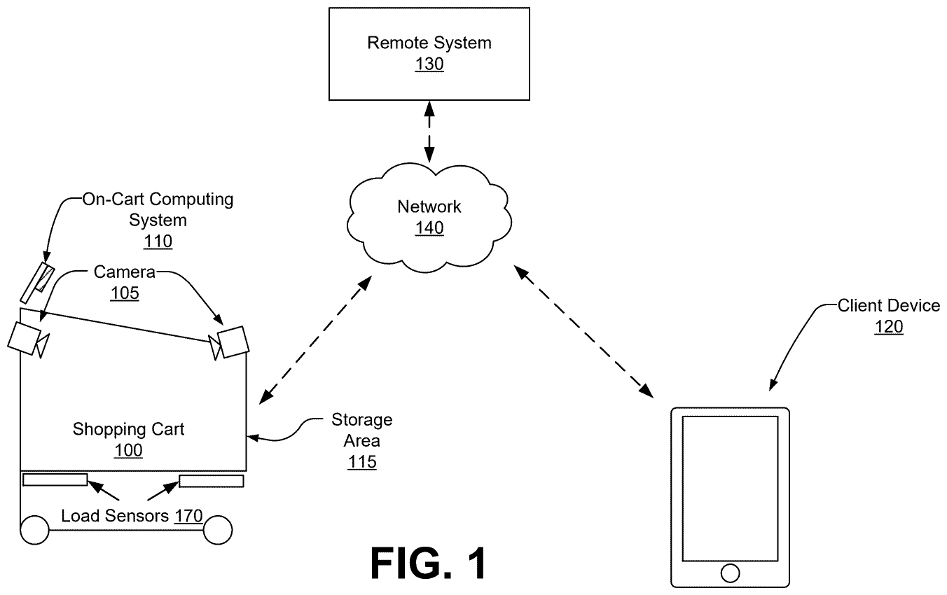

FIG. 1 illustrates an example system environment for a smart receptacle system, in accordance with one or more illustrative embodiments. In one or more embodiments, the receptacle is described in terms of a shopping cart. However, other types of receptacles may be used. The system environment illustrated in FIG. 1 includes a shopping cart 100, a client device 120, a remote system 130, and a network 140. Alternative embodiments may include more, fewer, or different components from those illustrated in FIG. 1, and the functionality of each component may be divided between the components differently from the description below. For example, functionality described below as being performed by the shopping cart may be performed, in some embodiments, by the remote system 130 or the client device 120. Similarly, functionality described below as being performed by the remote system 130 may, in some embodiments, be performed by the shopping cart 100 or the client device 120. Additionally, each component may perform their respective functionalities in response to a request from a human, or automatically without human intervention.

A shopping cart 100 is a type of receptacle or vessel that a user can use to hold objects such as items as the user travels through a store (e.g., a brick-and-mortar store). The shopping cart 100 is a physical shopping cart that is pushed or pulled through the store by the user, for example. The shopping cart 100 includes one or more cameras 105 that capture image data of the shopping cart's storage area and a user interface that the user can use to interact with the shopping cart 100. The shopping cart 100 may include additional components not pictured in FIG. 1, such as processors, computer-readable media, power sources (e.g., batteries), network adapters, or sensors (e.g., load sensors, thermometers, proximity sensors).

The cameras 105 capture image data of the shopping cart's storage area. The cameras 105 may capture two-dimensional or three-dimensional images of the shopping cart's contents. The cameras 105 are coupled to the shopping cart 100 such that the cameras 105 capture image data of the storage area from different perspectives. Thus, items in the shopping cart 100 are less likely to be overlapping in all camera perspectives. In some embodiments, the cameras 105 include embedded processing capabilities to process image data captured by the cameras 105. For example, the cameras 105 may be mobile industry processor interface (MIPI) cameras. The cameras 105 may be set to capture images from the area surrounding the shopping cart including the user of the cart. In some embodiments, at least one of the cameras 105 is directed outward, away from the shopping cart 100.

In some embodiments, the shopping cart 100 captures image data in response to detecting that an item is being added to the storage area. The shopping cart 100 may detect that an item is being added to the storage area 115 of the shopping cart 100 based on sensor data from sensors on the shopping cart 100. For example, the shopping cart 100 may detect that a new item has been added when the shopping cart 100 (e.g., load sensors 170) detects a change in the overall weight of the contents of the storage area 115 based on load data from load sensors. Similarly, the shopping cart 100 may detect that a new item is being added based on proximity data from proximity sensors indicating that something is approaching the storage area of the shopping cart 100. The shopping cart 100 may capture image data within a timeframe near when the shopping cart 100 detects a new item. For example, the shopping cart 100 may activate the cameras 105 which is an example of a sensor and store image data in response to detecting that an item is being added to the shopping cart 100 and for some period of time after that detection.

The shopping cart 100 may include one or more sensors that capture measurements describing the shopping cart 100, items in the shopping cart's storage area, or the area around the shopping cart 100. For example, the shopping cart 100 may include load sensors 170 that measure the weight of items placed in the shopping cart's storage area. Load sensors 170 are further described below. Similarly, the shopping cart 100 may include proximity sensors that capture measurements for detecting when an item is added to the shopping cart 100. The shopping cart 100 may transmit data from the one or more sensors to the remote system 130.

The one or more load sensors 170 capture load data for the shopping cart 100. In some embodiments, the one or more load sensors 170 may be scales that detect the weight (e.g., the load) of the content in the storage area 115 of the shopping cart 100. The load sensors 170 can also capture load curves—the load signal produced over time as an item is added to the cart or removed from the cart. The load sensors 170 may be attached to the shopping cart 100 in various locations to pick up different signals that may be related to items added at different positions of the storage area. For example, a shopping cart 100 may include a load sensor 170 at each of the four corners of the bottom of the storage area 115. In some embodiments, the load sensors 170 may record load data continuously while the shopping cart 100 is in use. In other embodiments, the shopping cart 100 may include some triggering mechanism, for example a light sensor, an accelerometer, or another sensor to determine that the user is about to add an item to the shopping cart 100 or about to remove an item from the shopping cart 100. The triggering mechanism causes the load sensors 170 to begin recording load data for some period of time, for example a preset time range.

The shopping cart 100 may include one or more wheel sensors (not shown) that measure wheel motion data of the one or more wheels. The wheel sensors may be coupled to one or more of the wheels on the shopping cart. In some embodiments, a shopping cart 100 includes at least two wheels (e.g., four wheels in the majority of shopping carts) with two wheel sensors coupled to two wheels. In further embodiments, the two wheels coupled to the wheel sensors can rotate about an axis parallel to the ground and can orient about an axis orthogonal or perpendicular to the ground. In other embodiments, each of the wheels on the shopping cart has a wheel sensor (e.g., four-wheel sensors coupled to four wheels). The wheel motion data includes at least rotation of the one or more wheels (e.g., information specifying one or more attributes of the rotation of the one or more wheels). Rotation may be measured as a rotational position, rotational velocity, rotational acceleration, some other measure of rotation, or some combination thereof. Rotation for a wheel is generally measured along an axis parallel to the ground. The wheel rotation may further include orientation of the one or more wheels. Orientation may be measured as an angle along an axis orthogonal or perpendicular to the ground. For example, the wheels are at 0° when the shopping cart is moving straight and forward along an axis running through the front and the back of the shopping cart. Each wheel sensor may be a rotary encoder, a magnetometer with a magnet coupled to the wheel, an imaging device for capturing one or more features on the wheel, some other type of sensor capable of measuring wheel motion data, or some combination thereof.

The shopping cart 100 includes an on-cart computing system 110 that enables the user to perform an automated checkout through the shopping cart 100. The computing system includes a processor and a non-transitory computer-readable medium that stores instructions that may be executed by the processor. The computing system 110 also may include a display, a speaker, a microphone, a keypad, or a payment system (e.g., a credit card reader). The computing system 110 also includes a wireless network adapter that allows the computing system to communicate via the network 140.

The on-cart computing system 110 allows a customer at a brick-and-mortar store to complete a checkout process in which items are scanned and paid for without having to go through a human cashier at a point-of-sale station. The on-cart computing system 110 receives data describing a user's shopping trip in a store and generates a shopping list based on items that the user has selected. For example, the on-cart computing system 110 may receive data from cameras or sensors coupled to the shopping cart 100 and may determine, based on the data, which items the user has added to their cart.

The on-cart computing system 110 may use machine-learning models or computer-vision techniques to identify items that the user adds to the shopping cart. For example, the on-cart computing system 110 may apply a barcode detection model to images captured by a camera of the shopping cart to identify items based on the barcodes that are visible to the camera. The barcode detection model is a machine-learning model (e.g., a neural network) that is trained to identify item identifiers that are encoded in barcodes that are depicted in image data. The barcode detection model may be trained based on a set of training examples. Each of the training examples may include an image of a barcode and a label that indicates what item identifier is encoded by the barcode. In some embodiments, the on-cart computing system 110 preprocesses the image before applying the barcode detection model to the image. For example, the on-cart computing system may rotate the image so that the barcode is aligned with a set direction or may crop an image of an item to a portion of the image that depicts the barcode. U.S. patent application Ser. No. 17/703,076, entitled “Image-Based Barcode Decoding” and filed Mar. 24, 2022, describes an example barcode detection model in accordance with some embodiments and is incorporated by reference.

The on-cart computing system also may store and apply an optical character recognition (OCR) model to the image. An OCR model is a machine-learning model that converts typed, handwritten, or printed text depicted in images into machine-readable text. The on-cart computing system applies the OCR model to images captured by the cameras to identify items depicted in those images. For example, the on-cart computing system may generate a set of OCR text for an image. This OCR text is text that the OCR model has identified as being depicted in the image. The on-cart computing system uses the OCR text to identify items in images. For example, the on-cart computing system may apply another machine-learning model (e.g., a large language model) to the OCR text to predict which item is depicted in the image based on the OCR text.

In some embodiments, the on-cart computing system uses an item lookup table to identify items depicted in an image based on OCR text extracted from that image. The item lookup table stores a set of items that may be depicted in images captured by the cameras and corresponding text that is associated with each of the items. The on-cart computing system stores the item lookup table for use in identifying items. For example, the on-cart computing system may compare OCR text from an image to the corresponding text for each of the items to identify items depicted in images. The on-cart computing system may identify the item by identifying which item in the item lookup table has the most characters or words in common with the OCR text or which item has the longest sequence of characters in common with the OCR text. In some embodiments, rather than storing text in the item lookup table, the item lookup table stores embeddings that represent text associated with items. In these embodiments, the on-cart computing system may generate an embedding for OCR text and compare that embedding to the embeddings stored in the item lookup table to identify the item.

Furthermore, the on-cart computing system may store and apply an image embedding model to captured images to identify items. The image embedding model is a machine-learning model that is trained to generate embeddings for images captured by the cameras. The on-cart computing system applies the image embedding model to images captured by the cameras of the shopping cart and uses the embeddings to identify which items are depicted in the images. For example, the on-cart computing system may store embeddings that correspond to items that a user may place in the shopping cart. Each item may be associated with a single embedding or multiple embeddings. The on-cart computing system applies the image embedding model to images captured by the cameras and compares the generated embeddings to stored embeddings for items. The on-cart computing system identifies which item or items are depicted in an image based on how similar the generated embeddings are to the stored embeddings corresponding to the items. For example, the on-cart computing system may compute a distance, dot product, or cosine similarity between the embeddings to identify the item in the images. U.S. patent application Ser. No. 17/726,385, entitled “System for Item Recognition using Computer Vision” and filed Apr. 21, 2022, describes example methodologies for identifying items using a machine-learning model and is incorporated by reference.

Any of these models may be sensor fusion models that take sensor data as additional inputs. For example, a model may use weight data from a load sensor or proximity data from a proximity sensor as an additional input to predict an identifier for an item added to the shopping cart.

The on-cart computing system 110 generates a shopping list for the user as the user adds items to the shopping cart 100. The shopping list is a list of items that the user has gathered in the storage area 115 of the shopping cart 100 and intends to purchase. The shopping list may include identifiers for the items that the user has gathered (e.g., stock keeping units (SKUs)) and a quantity for each item. When the user indicates that they are done shopping at the store, the on-cart computing system 110 interfaces with the remote system 130 to facilitate a transaction between the user and the store for the user to purchase their selected items. For example, the on-cart computing system 110 may receive payment information from the user through a user interface and transmit that payment information to the remote system 130.

The user interface of the on-cart computing system 110 may allow the user to adjust the items in their shopping list or to provide payment information for a checkout process. Additionally, the user interface may display a map of the store indicating where items are located within the store. In some embodiments, a user may interact with the user interface to search for items within the store, and the user interface may provide a real-time navigation interface for the user to travel from their current location to an item within the store. The user interface also may display additional content to a user, such as suggested recipes or items for purchase. In some embodiments, the on-cart computing system 110 may receive content from the remote system 130 to display to the user. For example, the on-cart computing system may receive item recommendations, recipe recommendations, or brand recommendations from the remote system 130.

The on-cart computing system may include a tracking system configured to track a position, an orientation, movement, or some combination thereof of the shopping cart 100 in an indoor environment. The tracking system may further include other sensors capable of capturing data useful for determining position, orientation, movement, or some combination thereof of the shopping cart. Other example sensors include, but are not limited to, an accelerometer, a gyroscope, etc. The tracking system may provide real-time location of the shopping cart to an online system or database. The location of the shopping cart may inform content to be displayed by the user interface. For example, if the shopping cart 100 is located in one aisle, the display can provide navigational instructions to a user to navigate them to a product in the aisle. In other example use cases, the display can provide suggested products or items located in the aisle based on the user's location.

A user can also interact with the shopping cart 100 or the remote system 130 through a client device 120. The client device 120 can be a personal or mobile computing device, such as a smartphone, a tablet, a laptop computer, or desktop computer. In some embodiments, the client device 120 executes a client application that uses an application programming interface (API) to communicate with the remote system 130 through the network 140. The client device 120 may allow the user to add items to a shopping list and to checkout through the remote system 130. For example, the user may use the client device 120 to capture image data of items that the user is selecting for purchase, and the client device 120 may provide the image data to the remote system 130 to identify the items that the user is selecting. The client device 120 may adjust the user's shopping list based on the identified item. In some embodiments, the user can also manually adjust their shopping list through the client device 120.

In some embodiments, the on-cart computing system 110, the cameras, and the sensors of the shopping cart are separately mounted to the shopping cart. Alternatively, the on-cart computing system 110, cameras, and sensors may be contained within a single casing that is mounted to the shopping cart. This single casing may contain all of the components needed by the on-cart computing system 110 to perform the functionalities described herein. The single casing may be permanently mounted to the shopping cart or may be configured to be easily attached to or detached from the shopping cart. This latter embodiment may enable the on-cart computing system 110 to be recharged at a separate station from the shopping cart or may allow the computing system 110 to be easily mounted to pre-existing shopping carts, rather than requiring specially built shopping carts.

The shopping cart 100 and client device 120 can communicate with the remote system 130 via a network 140. The network 140 is a collection of computing devices that communicate via wired or wireless connections. The network 140 may include one or more local area networks (LANs) or one or more wide area networks (WANs). The network 140, as referred to herein, is an inclusive term that may refer to any or all of standard layers used to describe a physical or virtual network, such as the physical layer, the data link layer, the network layer, the transport layer, the session layer, the presentation layer, and the application layer. The network 140 may include physical media for communicating data from one computing device to another computing device, such as MPLS lines, fiber optic cables, cellular connections (e.g., 3G, 4G, or 5G spectra), or satellites. The network 140 also may use networking protocols, such as TCP/IP, HTTP, SSH, SMS, or FTP, to transmit data between computing devices. In some embodiments, the network 140 may include Bluetooth or near-field communication (NFC) technologies or protocols for local communications between computing devices. The network 140 may transmit encrypted or unencrypted data.

The remote system 130 communicates with the on-cart computing system 110 of the shopping cart to provide an automated checkout experience for the user. The remote system 130 may facilitate the user's payment for the items in the shopping cart. For example, the remote system 130 may receive the user's shopping list from the shopping cart and charge the user for the cost of the items in the cart. The shopping list is the list of items included in the storage area 115 of the shopping cart 100. The remote system 130 may communicate with other systems to execute the transaction, such as a computing system of the retailer or of a financial institution. The remote system 130 may receive payment information from the shopping cart 100 and uses that payment information to charge the user for the items. Alternatively, the remote system 130 may store payment information for the user in user data describing characteristics of the user. The remote system 130 may use the stored payment information as default payment information for the user and charge the user for the cost of the items based on that stored payment information.

In some embodiments, the remote system 130 establishes a session for a user to associate the user's actions with the shopping cart 100 to that user. The user may establish the session by inputting a user identifier (e.g., phone number, email address, username, etc.) into a user interface of the remote system 130. The user also may establish the session through the client device 120. The user may use a client application operating on the client device 120 to associate the shopping cart 100 with the client device 120. The user may establish the session by inputting a cart identifier for the shopping cart 100 through the client application, e.g., by manually typing an identifier or by scanning a barcode or QR code on the shopping cart 100 using the client device 120. In some embodiments, the remote system 130 establishes a session between a user and a shopping cart 100 automatically based on sensor data from the shopping cart 100 or the client device 120. For example, the remote system 130 may determine that the client device 120 and the shopping cart 100 are in proximity to one another for an extended period of time, and thus may determine that the user associated with the client device 120 is using the shopping cart 100.

The remote system 130 may also provide content to the on-cart computing system 110 to display to the user while the user is operating the shopping cart. For example, the remote system 130 may use stored user data associated with the user of the shopping cart to select content that the user is most likely to interact with. The remote system 130 may transmit that content to the on-cart computing system for display to the user. The remote system 130 may also provide other data to the on-cart computing system. For example, the remote system 130 may store item data describing items in the store and the remote system 130 may provide that item data to the on-cart computing system for the on-cart computing system to use to identify items.

In some embodiments, a user who interacts with the shopping cart 100 or the client device 120 may be an individual shopping for themselves or a shopper for an online concierge system. The shopper is a user who collects items from a store on behalf of a user of the online concierge system. For example, a user may submit a list of items that they would like to purchase. The online concierge system may transmit that list to a shopping cart 100 or a client device 120 used by a shopper. The shopper may use the shopping cart 100 or the client device 120 to add items to the user's shopping list. When the shopper has gathered the items that the user has requested, the shopper may perform a checkout process through the shopping cart 100 or client device 120 to charge the user for the items. U.S. Pat. No. 11,195,222, entitled “Determining Recommended Items for a Shopping List,” issued Dec. 7, 2021, describes online concierge systems in more detail, which is incorporated by reference herein in its entirety.

In some embodiments, the remote system 130 predicts a state of the shopping cart 100 in real-time. The state of the shopping cart is indicative of items that are predicted to be in the storage area 115 of the shopping cart 100. Although the on-cart computing system 110 may generate the shopping list of items in the storage area 115 of the shopping cart 100 as described above, the shopping list may be inaccurate due to user actions towards the shopping cart 100 being misinterpreted by the on-cart computing system 110. As will be further be described below, the remote system 130 may apply a rule-based model or a large language model to cart sensor data to accurately predict the state of the shopping cart 100 in real-time despite the cart sensor data reflecting complex user behavior performed on the shopping cart 100.

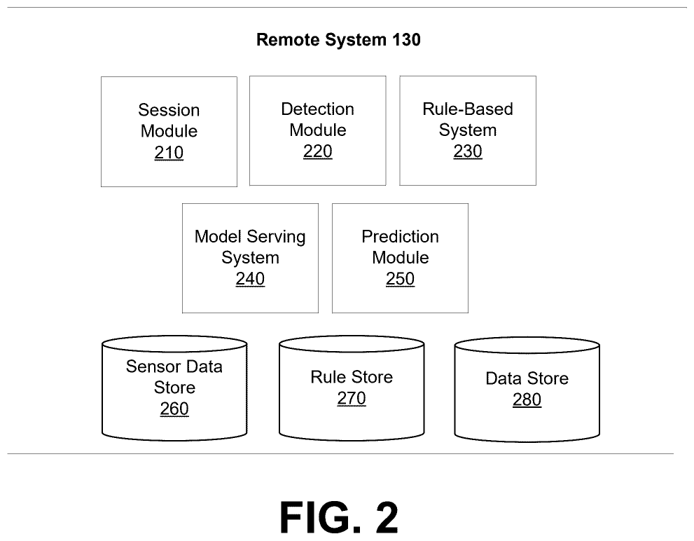

FIG. 2 illustrates a high-level block diagram of a system architecture for the remote system 130, in accordance with one or more embodiments. The system architecture illustrated in FIG. 2 includes a session module 210, a detection module 220, a rule-based system 230, a model serving system 240, a prediction module 250, a sensor data store 260, a rule store 270, and a data store 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data store 280 stores item data which is information or data that identifies and describes items that are available at a retailer location (e.g., a brick-and-mortar store) at which the shopping cart 100 is located. The item data may include item identifiers for items that are available and may include quantities of items associated with each item identifier. Additionally, item data may also include attributes of items such as the cost (e.g., price), size, color, weight, stock keeping unit (SKU), or serial number for the item. The item data may further include purchasing rules associated with each item, if they exist. For example, age-restricted items such as alcohol and tobacco are flagged accordingly in the item data.

The data store 280 may also store data describing a user if the user has previously explicitly consented to the remote system 130 collecting data describing the user. The user data including sensitive or personal data describing users may be encrypted. User data may include a user's name, address, shopping preferences, favorite items, or stored payment instruments for automatic checkout at the shopping cart 100.

The session module 210 establishes a session between a client device 120 and a shopping cart 100. A session is an association of the shopping cart 100 with the client device 120 such that actions taken with respect to the shopping cart 100 are associated with a user corresponding to the client device 120. For example, if a session is established between a shopping cart 100 and a client device 120, the remote system 130 or the on-cart computing system 110 may associate items added to the storage area 115 of the shopping cart 100 with the user corresponding to the client device 120 so that the user is charged for the items. The session may be initiated responsive to the user logging into a user account via the on-cart computing system 110. Alternatively, the user may log into the user account using the client device 120. The session may be ended once the user purchases items in the shopping cart 100 or by the user logging out of the user account.

The detection module 220 detects and logs cart sensor data from sensors on the shopping cart 100 during the session. The cart sensor data is indicative of an event or action that occurred with respect to a set of items and the shopping cart 100. The occurrence of an event signifies that a user has interacted with the shopping cart 100. An item being added to the storage area 115 of the shopping cart 100 is an example of an event. Another example of an event is an item being removed from the storage area 115 of the shopping cart 100. In yet another example, the user purchasing the items in the shopping cart 100 is an example of an event.

The detection module 220 may detect cart sensor data received from the sensors of the shopping cart 100 and logs the detected cart sensor data in the cart sensor data store 260. For example, the detection module 220 generates a log file for the session that includes a list of the detected cart sensor data. The log file may include the time/date at which each cart sensor data was detected and an identifier of the sensor that provided the cart sensor data. The detection module 220 may update the log file for the session as cart sensor data is received from the sensors of the shopping cart 100 in real-time. The log file may be used by the rule-based system 230 or the model serving system 240 to predict the state of the shopping cart 100 throughout the duration of the session.

The rule-based system 230 predicts a state of the shopping cart 100 based on rules stored in the rule store 270 and the cart sensor data for the session. In some embodiments, the state of the shopping cart 100 indicates the predicted items that are currently in the storage area 115 of the shopping cart 100 during the session. Thus, the rule-based system 230 generates a prediction of items that are in the storage area 115 of the shopping cart 100. The rule-based system 230 compares cart sensor data from the log file with the rules to determine one or more actions that have taken place with respect to the shopping cart 100 and the items corresponding to the actions. The rule-based system 230 determines the prediction of the state of the shopping cart 100 from the actions and related items. Table 1 shown below illustrates an example of rules stored in the rule data store 260 that are compared against action events. The rules in Table 1 are for example purposes only and other rules may be used by the rule-based system 230.

TABLE 1

| Rule | | |
|---|---|---|
| Number | Rule | Action |
| 1 | Weight associated with item | The item is added to |
| | identified from barcode | shopping cart |
| | matches weight added to the | |
| | shopping cart | |
| 2 | Weight associated with item | The item is added to |
| | identified from image matches | shopping cart |
| | weight added to the shopping | |
| | cart | |
| 3 | Amount of weight reduction of | The item is removed from |
| | shopping cart matches weight | the shopping cart |
| | of item previously identified in | |
| | the shopping cart | |
| 4 | Weight associated with item | Uncertain of the action |
| | identified from barcode does | |
| | not match weight added to the | |
| | shopping cart | |
| 5 | Weight associated with item | Uncertain of the action |
| | identified from image does not | |
| | match weight added to the | |
| | shopping cart | |

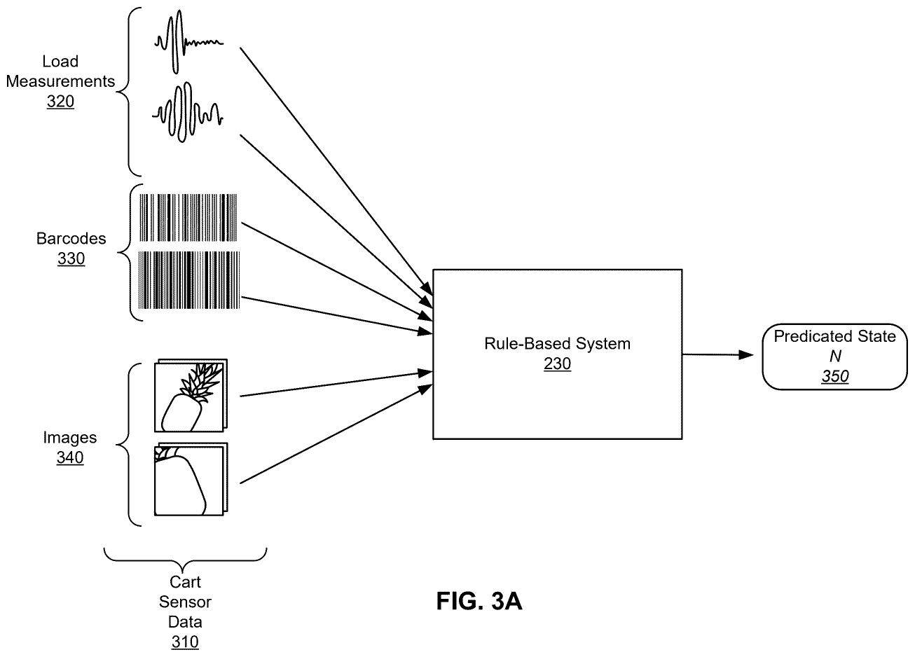

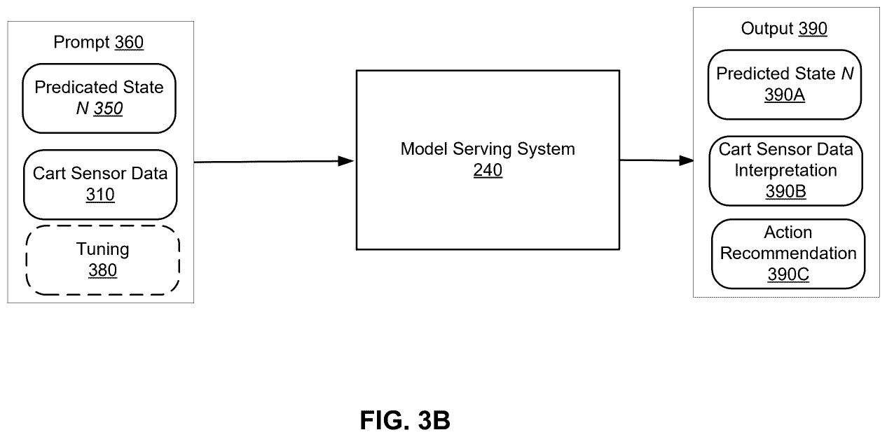

FIG. 3A is a high-level diagram of a process performed by the rule-based system 230 during which a rule-based model is applied to cart sensor data to predict a state of the shopping cart, in accordance with one or more example embodiments. The rule-based system 230 receives the cart sensor data 310 of the shopping cart 100 during the session. For example, the rule-based system 230 receives the log file including the list of cart sensor data 310 for the session. The rule-based system 230 may receive the cart sensor data 310 of the shopping cart 100 multiple times during the session. For example, the rule-based system 230 may receive the cart sensor data 310 each time the detection module 220 updates the log file of cart sensor data for the session to ensure that the most up to date state of the shopping cart 100 is displayed to the user via the on-cart computing system 110.

The cart sensor data 310 received by the rule-based system 230 includes load measurements 320 from the load sensors 170, barcodes 330 included in images captured by the cameras 105, and the images that include at least a portion of an item, for example. The rule-based system 230 applies the cart sensor data 310 to the rules stored in the rule store 270 to determine one or more actions performed by the user with respect to the shopping cart 100 from the cart sensor data 310.

For example, if a barcode 330 is included in the cart sensor data 310, the rule-based system 230 retrieves from the data store 280 the weight of an item corresponding to the barcode 330. The rule-based system 230 identifies the weight added to the shopping cart 100 from the load measurements 320 that corresponds to the barcode 330. The rule-based system 230 compares the weight of the item corresponding to the barcode 330 and the identified weight added to the shopping cart 100. If the compared weights match, the rule-based system 230 determines that the item corresponding to the barcode 330 was added to the shopping cart (e.g., Rule Number 1).

In another example, if an image of an item is included in the cart sensor data 310, the rule-based system 230 retrieves the weight of the item from the data store 280. The rule-based system 230 identifies the weight added to the shopping cart 100 from the load measurements 320 that corresponds to the image 340. The rule-based system 230 may identify the load measurement that corresponds to the image 340 based on the time stamps associated with each cart sensor data. The rule-based system 230 compares the weight of the item corresponding to image 340 and the identified weight added to the shopping cart 100. If the compared weights match, the rule-based system 230 determines that the item corresponding to the image 340 was added to the shopping cart (e.g., Rule Number 2).

In another example, the rule-based system 230 identifies the weight of the shopping cart 100 is reduced compared to a prior weight of the shopping cart from the load measurements 320. The rule-based system 230 compares the magnitude of the reduced weight with the weight of each item previously identified as being added to the shopping cart 100. If the magnitude of the reduced weight of the shopping cart matches the weight of the identified item, the rule-based system 230 determines that the item was removed from the shopping cart (e.g., Rule Number 3).

The rule-based system 230 outputs a predicted state N 350 of the shopping cart 100 during the session where Nis a natural number (1, 2, 3, etc.). As mentioned above, the rule-based system 230 may predict the state of the shopping cart 100 multiple times during the session. Each predicted state N 350 includes a prediction of items in the storage area 115 of the shopping cart 100 at a corresponding time during the session.

In some embodiments, the rule-based system 230 determines that it is uncertain of the type of action that took place from a portion of the cart sensor data 310. That is, a portion of the cart sensor data 310 cannot be resolved into a type of action (e.g., add or remove) because the portion of the cart sensor data 310 corresponds to a complex interaction between the user and the shopping cart. As a result, the prediction by the rule-based system 230 may be inaccurate due to the rule-based system 230 being unable to extrapolate beyond the existing pre-coded rules shown in Table 1. The rule-based system 230 may still predict a state of the shopping cart 100, but may include an indication (e.g., a flag) regarding the uncertainty of the accuracy of the prediction due to being unable to resolve the type of action that took place from the cart sensor data.

An example of a complex interaction that may result in the uncertainty of the prediction formed by the rule-based system 230 is shuffling of items within the shopping cart. During shuffling of the items, the user may pick up an item from a first location in the storage area 115 of the shopping cart 100 and move the item to a second location in the storage area 115. The first location and the second location may be different from each other or the same location. As a result of the shuffling, weight of the shopping cart 100 measured by the load sensors 170 may show a momentary change in weight despite the weight of the shopping cart 100 matching the prior weight of the shopping cart after the item is moved to the second location. This weight fluctuation may confuse the rule-based system 230.

Furthermore, as a result of the shuffling, the cameras 105 of the shopping cart 100 may capture an image of the bar code of the item or an image of the item itself when the user moves the item from the first location to the second location. The rule-based system 230 may be unable to identify the action that occurred on the shopping cart 100 due to the resulting weight of the shopping cart 100 not increasing from the prior weight of the shopping cart despite the rule-based system 230 identifying an item corresponding to the barcode/image that appears to have been added to the shopping cart 100. Thus, the rule-based system 230 may still output a predicted state of the shopping cart 100, but with an indication of the uncertainty of the accuracy of the prediction.

In another example of a complex interaction, the user may add multiple quantities of the same item to the shopping cart 100 at the same time. While the item may be identified from cart sensor data (e.g., barcode/image of the item), the resulting weight added to the shopping cart 100 may not match the expected weight of the identified item. Thus, the rule-based system 230 is unable to decipher that multiple quantities of the same item were added to the shopping cart 100. The rule-based system 230 is thus unable to determine the action that occurred with respect to the shopping cart 100 from the cart sensor data due to the complex interactions from the cart sensor data 310. The rule-based system 230 may still output a predicted state of the shopping cart 100, but with an indication of the uncertainty of the accuracy of the prediction.

The rule-based system 230 generates a set of actions that occurred on the shopping cart 100 from the cart sensor data 310 where each action in the set is associated with a corresponding item. The rule-based system 230 determines the items included in the shopping cart 100 for inclusion in the predicted state of the shopping cart 100 from the items that are associated with the set of actions. For example, if the set of actions includes an action of adding flour, adding sour cream, removing sour cream, adding sunscreen, adding chicken breast, and adding lemonade to the shopping car, the rule-based system 230 determines that flour, sunscreen, chicken breast, and lemonade are in the shopping cart 100 based on the actions.

Referring back to FIG. 2, the model serving system 240 receives requests from the prediction module 250 to output a state of the shopping cart 100 during the session. The machine-learned language model served by the model serving system 240 is better equipped to understand complex user behavior with the shopping cart 100 than the rule-based system 230. As a result, the accuracy of the predicted state of the shopping cart 100 is improved compared to if only the rule-based system 230 is used to make predictions regarding the state of the shopping cart 100.

The model serving system 240 may supplement the rule-based system 230 to provide the state of the shopping cart 100 during the session. For example, the model service system 240 may receive the request to output the state of the shopping cart 100 when the rule-based system 230 outputs the predicted state of the shopping cart with an indication of the uncertainty of the prediction as described previously. Alternatively, the model serving system 240 may operate in parallel with the rule-based system 230 to output the predicted state of the shopping cart 100 during the session. In another example, the model serving system 240 may replace the rule-based system 230 as the mechanism for predicting the state of the shopping cart 100.

In one or more embodiments, the model serving system 240 performs inference tasks using machine-learned models to predict the state of the shopping cart 100. The inference tasks include, but are not limited to, natural language processing (NLP) tasks, audio processing tasks, image processing tasks, video processing tasks, and the like. In one or more embodiments, the machine-learned models deployed by the model serving system 240 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 240 receives a request including input data (e.g., text data such as the load measurements, image data such as bar codes or images of items, or video data of the bar codes or items) and encodes the input data into a set of input tokens. The model serving system 240 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models). In one instance, the LLM may be trained and hosted on a cloud infrastructure service. The LLM may be trained by the remote system 130 or entities/systems different from the remote system 130. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more other embodiments, the transformer architecture may have an encoder-decoder architecture and includes a set of encoders coupled to a set of decoders. An encoder or decoder may include one or more attention operations.

While a LLM with a transformer-based architecture is described in one or more embodiments, alternatively, the language model may be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a query and additional contextual information that is useful for responding to the query. The LLM infers the response to the query from the knowledge that the LLM was trained on or from the contextual information included in the prompt.

In one or more embodiments, given at least cart sensor data of the session, the remote system 130 performs an inference task in conjunction with the model serving system 240 to output the state of the shopping cart 100 during the session. The model serving system 240 is able to interpret complex interactions between the user and the shopping cart 100 that are represented by the cart sensor data. Thus, the model serving system 240 better understands complex user behavior compared to the ruled-based system 230.

For example, the model serving system 240 is capable of interpreting from the cart sensor data that an item was not added or removed from the shopping cart 100 during shuffling of items within the shopping cart 100. In another example, the model serving system 240 is capable of identifying from the cart sensor data that multiple quantities of the same item are added to the shopping cart 100 at the same time. The model serving system 240 may also be capable of detecting potential fraud. As a result, the model serving system 240 can output the state of the shopping cart 100 despite the complex user interactions with the shopping cart 100 whereas the predicted state of the shopping cart 100 output by the rule-based system 240 may be inaccurate. Thus, when the remote system 130 provides the predicted state of the shopping cart to the on-cart computing system 110 for display, the user is provided with an accurate list of items in the shopping cart 100.

The prediction module 250 predicts the state of the shopping cart 100 in conjunction with the model serving system 240. The prediction module 250 constructs one or more prompts for input to the model serving system 240. Specifically, the prediction module 250 generates a prompt that includes a request of the inference task to be performed by the machine-learned model and contextual information for the inference task. In some embodiments, the prompt generated by the prediction module 250 includes a request to output a prediction of the state of the shopping cart 100 during the session, the predicted state N from the rule-based system 230, and the cart sensor data used by the rule-based system 230 to generate the predicted state N. In some embodiments, the prompt generated by the prediction module 250 may include tuning data based on user validations of the accuracy of prior predictions of the state of the shopping cart 100 during the session or the user's historical sessions. The prompt may also define the format of the output of the machine-learned model (e.g., JSON). An example prompt to an LLM may be:
“Given a list of items: unbleached all-purpose flour, sour cream, sunscreen, whole organic chicken breast, organic lavender lemonade, and tomatoes canned, load measurements A, B, C, D, E, F, G, bar codes 1, 2, 3, 4, 5, 6, 7, and images A1, A2, A3, A4, A5, A6, A7, and A8 what is the predicted state of the shopping cart at this time?”

The prediction module 250 receives an output from the machine-learned model of the model serving system 240 as a response to the prompt. The prediction module 250 extracts the predicted items in the shopping cart 100 from the output of the machine-learned model.

While the output of an LLM may be formatted, for example, in a dialogue format, the prediction module 250 parses the output to extract meaningful information describing predicted state of the shopping cart 100.

As an example, the output of the machine-learned model (e.g., LLM) from the model serving system 240 may be:
“Based on the list of items, load measurements, bar codes, and images provided, the predicted state of the shopping cart includes 1 count of unbleached all-purpose flour, 1 count of sour cream, 1 count of sunscreen, 1 count of whole organic chicken breast, 1 count of organic lavender lemonade, and 2 counts of tomatoes canned.”

The prediction module 250 may parse the output from the model serving system 240 to predict the state of the shopping cart 100. That is, the prediction module 250 identifies a prediction of items that are in the storage area of the shopping cart 100 from the output of the model serving system 240. The state of the shopping cart 100 may include a list of the items in the shopping cart 100 and the quantity of each item.

The prediction module 250 may also extract from the output of the machine learned model interpretations of cart sensor data including cart sensor data that signifies complex interactions between the user and the shopping cart 100. Each interpretation is indicative of an action performed by the user with respect to the shopping cart 100 and an item related to the action thereby resulting in a list of actions and their corresponding items. In some embodiments, each interpretation is one of an item being added, an item being removed, an item not being added or removed (e.g., as a result of shuffling of items), or possible fraud.

The prediction module 250 may also extract one or more recommended actions to present to the user via the on-cart computing system 110 from the output of the machine learned model. The action helps guide the user to quickly resolve any issues that occur during the session. The actions may include a requirement for a manual check out instead of an automatic checkout via the shopping cart 100 due to the model serving system 240 being uncertain about the predicted state of the shopping cart 100. During the manual checkout, the user would scan each item in the shopping cart at a cash register for example. The actions may also include a suggestion to request help from an employee of the brick-and-mortar store to resolve the uncertainty regarding the predicted state of the shopping cart 100 so that the user can automatically checkout via the shopping cart 100. The manual check out may also be required if the output of the machine learned model indicates the detection of possible fraud or if alcohol is detected in the shopping cart 100 thereby requiring an identification check that the user meets the age requirements to purchase alcohol.

In some embodiments, in response to the output of the machine learned model indicating possible fraud or detection of alcohol, one or more actions are automatically performed. For example, the employee of the brick-and-mortar may be automatically deployed. A status of the employee in the remote system 130 may be automatically updated from being available to being unavailable as the employee is performing a manual check out review. Furthermore, the employee may be notified that assistance is required by automatically illuminating one or more lights on the shopping cart 100 that flag the shopping cart 100 for manual review in response to the shopping cart 100 receiving an instruction from the remote system 130 to illuminate the lights. Additionally in the case of fraud, the wheels of the shopping cart may be automatically locked in response to an instruction from the remote system 130 to lock the wheels after fraud is detected.

FIG. 3B is a high-level diagram for applying a large language model that supplements the rule-based model to the cart sensor data to predict a state of the shopping cart, in accordance with one or more example embodiments. The model serving system 240 may be employed to supplement the rule-based system 230 because of complex interactions in the cart sensor data 310 that cannot be interpreted by the rule-based system 230, for example.

The model serving system 240 receives a prompt 360 from the prediction module 250. The prompt 360 may include the predicted state N 350 of the shopping cart 100 output by the rule-based system 230. The prompt 360 may also include the cart sensor data 310 used by the rule-based system 230 to generate the predicted state N 350. The prompt 360 may optionally include tuning data 380 based on user validations of the accuracy of prior predictions of the state of the shopping cart 100 during the session or the user's historical sessions.

The model serving system 240 generates an output 390 in response to the prompt. The output 390 includes the predicted state N 390A of the shopping cart. The predicted state N 390A includes a predicted list of items in the shopping cart 100 that was predicted despite the complex interactions in the cart sensor data 310. The output 390 also includes one or more cart sensor data interpretations 390B of the cart sensor data 310. As described above, each interpretation indicates an action performed on the shopping cart 100 and a corresponding item related to the action. For example, one or more series of cart sensor data 370 may be interpreted to represent a particular action performed with respect to the cart such as an item being added, an item being removed, or an item not being added or removed as a result of reshuffling of items. Lastly, the output 390 may also include an action recommendation 390C to present to the user via the on-cart computing system 110. As mentioned above, the actions may include a requirement for a manual check out due to uncertainty about the predicted state 390A or fraud or to request assistance from an employee.

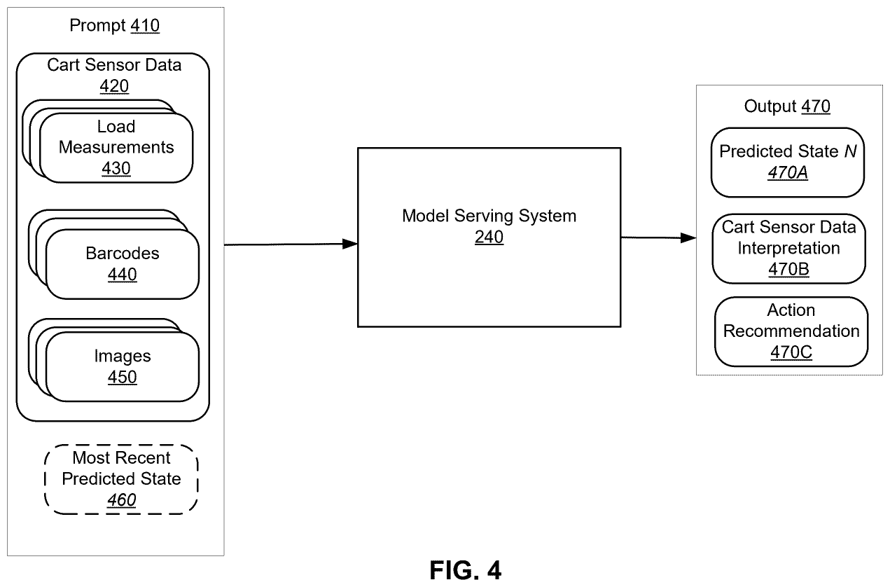

FIG. 4 is a high-level diagram of a process of the model serving system 240 that works in parallel with or replaces the rule-based system 230, in accordance with one or more example embodiments.

The model serving system 240 receives a prompt 410 from the prediction module 250. The prompt 410 may also include cart sensor data 420 comprising load measurements 430 of the shopping cart 100, barcodes 440 of items identified in images, and images 450 of items. The prompt 410 may include the most recent predicted state N 460 of the shopping cart 100 output by the model serving system 240 if available.

The model serving system 240 generates an output 470 in response to the prompt. The output 390 includes the predicted state N 470A of the shopping cart 100 comprising a predicted list of items in the shopping cart 100. The output 390 also includes one or more cart sensor data interpretations 390B of the cart sensor data 370 that each indicate a user action performed on the shopping cart 100 and an item related to the user action such as an item being added, an item being removed, an item not being added or removed as a result of reshuffling of items. Lastly, the output 390 may also include an action recommendation 470C to present to the user via the on-cart computing system 110 such as a requirement for a manual check out due to uncertainty about the predicted state 470A or fraud or a suggestion to request assistance from an employee to resolve the uncertainty.

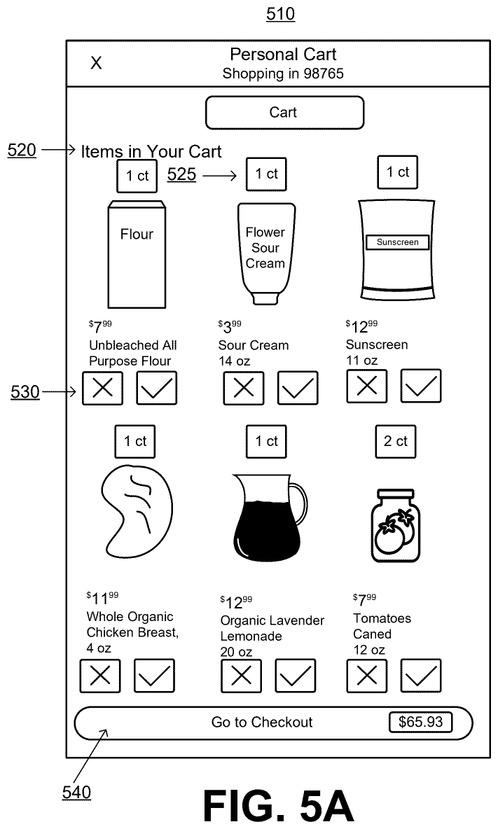

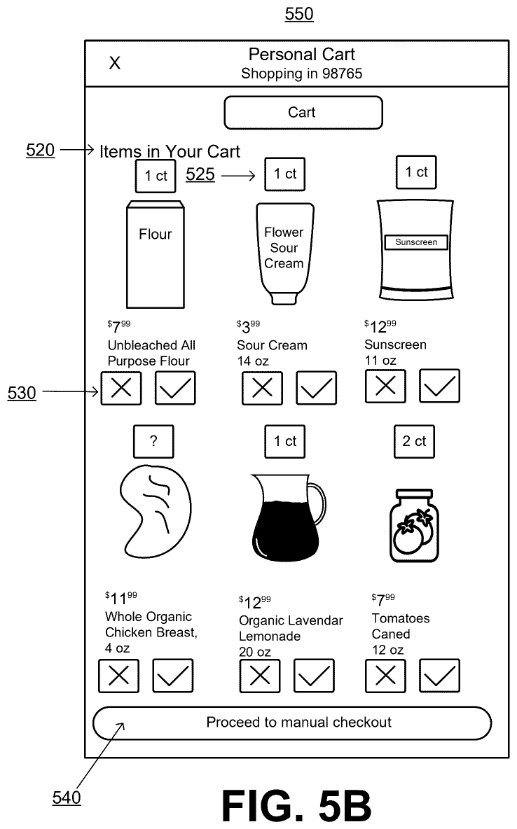

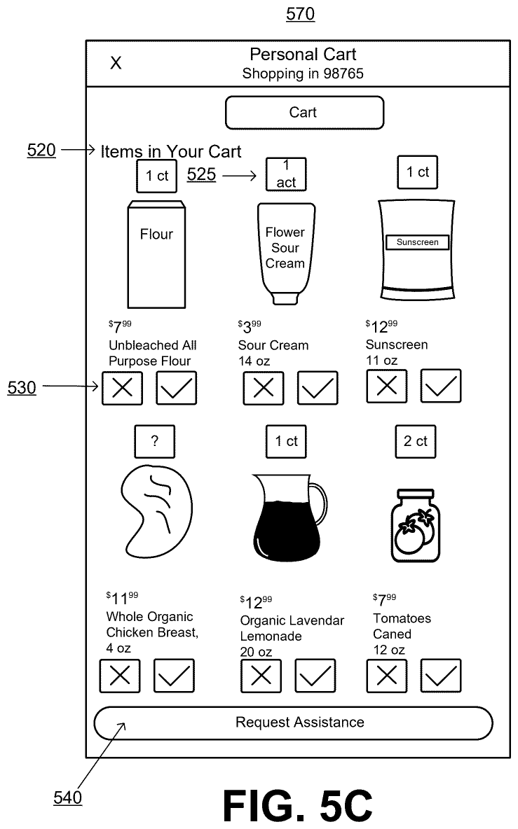

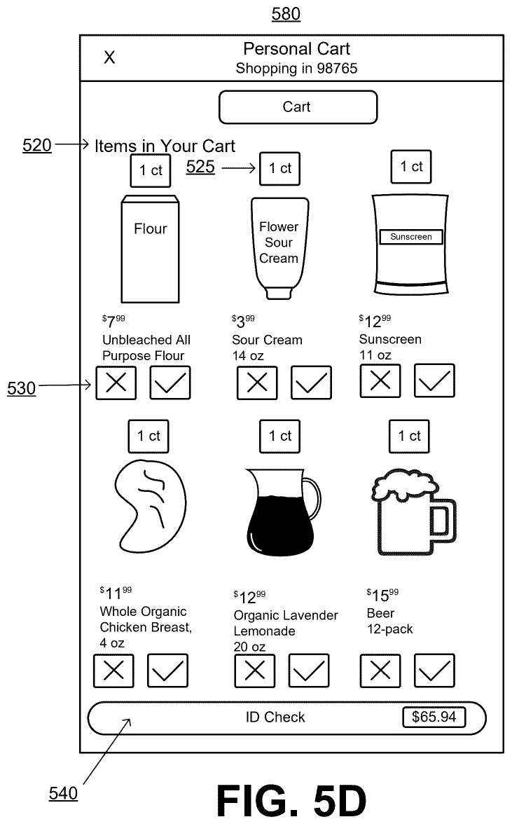

FIGS. 5A, 5B, 5C, and 5D are example user interfaces that present the predicted state of the shopping cart, in accordance with one or more embodiments. FIG. 5A illustrates a UI 510 that includes the predicted state of the shopping cart 100. Specifically, the UI 510 includes a list 520 of the items that were predicted to be currently in the shopping cart 601 during the session. For each item, the UI 510 includes the predicted quantity 525 of the item. The quantity of the item “tomatoes canned” is two. During the session, the user may have added two of the items to the shopping cart at the same time which is an example of a complex interaction with the shopping cart 100. However, due to the usage of the model serving system 240, the remote system 130 is accurately able to predict not only the item that was added to the cart but the quantity of the items despite multiple quantities of the canned tomatoes being added to the shopping cart 100 at the same time. Furthermore, during the session, the user may have shuffled the items in the shopping cart when the user added the unbleached all-purpose flour to the shopping cart 100. However, despite the shuffling, the remote system 130 was able to identify the action of shuffling the items and an accurate list of items in the shopping cart 100.

Each item additionally includes a UI element 530 for the user to provide feedback for the predicted item. A user interaction with the checkmark symbol is a positive feedback signal (e.g., a positive interaction) that indicates that the predicted item and quantity is accurate. In contrast, a user interaction with the cross symbol is a negative feedback signal (e.g., a negative interaction) that indicates that at least one of the predicted item or quantity is inaccurate. The lack of user interaction with the cross symbol may also be an indication of positive feedback.

In one or more embodiments, the prediction module 250 may perform an iterative training or fine-tuning process, where the machine-learned model is initially fine-tuned with data instances obtained from previous predictions of items in the shopping cart during the session or previous predictions of items from the user's purchase history. For example, during the session, the machine-learned model may generate multiple predictions of the state of the shopping cart, and the user may provide feedback on whether one or more of the predictions are accurate using UI elements 530. The prediction module 250 may generate a training data set including a set of data instances where each data instance includes inputs comprising the list of items and the feedback for each item. Based on the training data set, the prediction module 250 may retrain or re-fine-tune the machine-learned model to reduce errors, e.g., false positives or false negatives for the predicted state of the shopping cart 100.

Lastly, the UI 510 also includes a recommended action 540. Here, the recommended action is for the user is to complete the session by performing the checkout process to purchase the items in the shopping cart 100. Here, the recommended action is to checkout due to the remote system 130 being able to predict the state of the shopping cart 100 with enough certainty that the prediction is accurate. As a result, the user can checkout at the shopping cart 100 without having to manually scan each item in the shopping cart or checkout at a cash register that is separate from the shopping cart 100.

FIG. 5B illustrates a UI 550. The UI 550 includes similar features as UI 510 such as the list 520 of the items that were predicted to be currently in the shopping cart 601 during the session, the feedback UI element 530, and the predicted quantity 525 of each item. In the example of FIG. 5B, the quantity of the whole organic chicken breast is unknown. The quantity may be unknown due to potential fraud, for example. As a result, the recommended action 540 is to proceed to a manual checkout. During the manual checkout, an employee of the brick-and-mortar store can confirm the quantity of the item.

FIG. 5C illustrates a UI 570. The UI 570 includes similar features as UI 510 and UI 550 such as the list 520 of the items that were predicted to be currently in the shopping cart 100 during the session, the feedback UI element 530, and the predicted quantity 525 of each item. In the example of FIG. 5C, the quantity of the whole organic chicken breast is unknown due to potential fraud similar to the example of UI 510 in FIG. 5B. As a result, the recommendation action 540 is to proceed to request assistance which causes an employee of the brick-and-mortar store to confirm the quantity of the item. Once the quantity is confirmed by the employee via an employee device, the UI 570 may be updated with the quantity of the item and the recommendation action 540 is updated to proceed to checkout as shown in UI 510.

FIG. 5D illustrates a UI 570. The UI 570 includes similar features as UI 510, UI 550, and UI 570 such as the list 520 of the items that were predicted to be currently in the shopping cart 601 during the session, the feedback UI element 530, and the predicted quantity 525 of each item. In the example of FIG. 5D, the shopping cart includes alcohol (e.g., beer). As a result, the recommended action 540 is to request an identification check which causes an employee of the brick-and-mortar store to confirm that the user is of legal age to purchase alcohol. Once the age of the user is confirmed to at least match the legal age via an employee device of the employee, the UI 570 may be updated with the recommended action 540 to proceed to checkout as shown in UI 510.

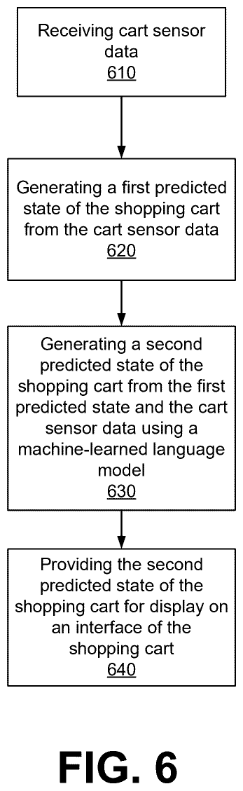

FIG. 6 is a flowchart describing prediction of a state of the shopping cart, in accordance with one or more embodiments. The remote system 130 receives 610 cart sensor data from sensors on the shopping cart 100 as a user interacts with the shopping cart 100. The interactions may include adding items to the storage area 115 of the shopping cart or removing items from the storage area 115 of the shopping cart 100. The cart sensor data may include load measurements from the load sensors 170 of the shopping car, images of bar codes extracted from images captured by cameras 105, and images of items captured by the cameras 105.

The remote system 130 generates 620 a first predicted state of the shopping cart from the cart sensor data. The first predicted state includes a prediction of the items in the storage area 115 of the shopping cart 100. The first predicted state may be generated by the rule-based system 230. Alternatively, the first predicted state may be generated by the model serving system 240.

The remote system 130 generates 630 a second predicted state of the shopping cart. For example, the model serving system 240 may receive a prompt to predict the state of the shopping cart from the first predicted state and the cart sensor data. The second predicted state includes the list of items predicted to be in the shopping cart. In some embodiments, the model serving system 240 also outputs interpretations of the cart sensor data that indicate whether one or more cart sensor data signifies the addition of an item to the shopping cart, a removal of the item from the shopping cart, or an item was shuffled within the shopping cart. The model serving system 240 may also output a recommended action for the user such as to end the session by purchasing the items in the shopping cart, manually checking out such as at a cash register at the brick-and-mortar store, or requesting assistance from an employee at the store.

The remote system 130 may generate the second predicted state due to uncertainty about the accuracy of the first predicted state because of a complex interaction represented in the cart sensor data that cannot be deciphered by the rule-based system 230, for example. In another example, the first predicted state is a prediction that was performed earlier in the session by the model serving system 240, and the second prediction of the state of the shopping cart 100 is generated to identify the items currently in the shopping cart 100.

The remote system 130 provides the second predicted state of the shopping cart to the shopping cart 100. The shopping cart displays the second predicted state of the shopping cart on an interface of the shopping cart and the recommended action.

Although the embodiments described herein are described as taking place on the remote system 130, in other embodiments the session module 210, the detection module 220, the rule-based system 230, the model serving system 240, the prediction module 250, the sensor data store 260, the rule store 270, and the data store 280 may be located on the on-cart computing system 110. As a result, the on-cart computing system 110 is capable of predicting the state of the shopping cart 100 according to the techniques described herein rather than relying upon the remote system 130 to formulate the predicted state of the shopping cart 100.

By implementing the techniques on the shopping cart 100 itself, the on-cart computing system 110 may communicate with other shopping carts in the brick-and-mortar store to gain insights on activity across different shopping carts. For example, the on-cart computing system 110 may identify actions or items that are causing the shopping cart 100 and other shopping carts issues such as the inability of the shopping carts 100 to predict their respective state.

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed is:

1. A method comprising, at a computer system comprising a processor and a non-transitory memory:
detecting, by one or more sensors on a receptacle, receptacle sensor data describing a set of actions with respect to a set of items and the receptacle;
generating a first prediction of items from the set that are in a storage area of the receptacle from the receptacle sensor data;
generating a prompt for input to a machine-learned language model, the prompt specifying the first prediction, the receptacle sensor data, and a request for a prediction of items from the set that are in the storage area of receptacle;
receiving, from the machine-learned language model, a response generated by executing the machine-learned language model on the prompt;
parsing the response from the machine-learned language model to extract information identifying a second prediction of items from the set that are in the storage area of the receptacle; and
transmitting instructions to an interface of the receptacle to cause a display of the second prediction of items on the interface of the receptacle.

2. The method of claim 1, wherein detecting the receptacle sensor data comprises detecting load measurements of the receptacle, images of bar codes of items added to the receptacle, and images of the items added to the receptacle.

3. The method of claim 1, wherein generating the first prediction of items comprises:
receiving, by a rule-based model, the receptacle sensor data;
comparing, by the rule-based model, the receptacle sensor data to stored rules to determine the set of actions from the receptacle sensor data; and
identifying items to include in the first prediction of items from the set of actions.

4. The method of claim 3, further comprising:
identifying, by the rule-based model, that a portion of the receptacle sensor data cannot be resolved into an action,
wherein the first prediction of items includes an indication regarding an uncertainty of an accuracy of the first prediction of items due to the portion of the receptacle sensor data not being resolved into the action.

5. The method of claim 4, wherein the portion of the receptacle sensor data is indicative of an item from the first prediction of items being moved from a first location within the receptacle to a second location in the receptacle.

6. The method of claim 4, wherein the prompt for input to the machine-learned language model is generated responsive to the indication regarding the uncertainty of the accuracy of the first prediction of items.

7. The method of claim 4, wherein parsing the response comprises:
extracting the action that corresponds to the portion of the receptacle sensor data that could not be resolved by the rule-based model from the response of the machine-learned language model.

8. The method of claim 1, further comprising:
generating a training dataset including a set of data instances, wherein a data instance includes inputs comprising the second prediction of items and expected outputs comprising items from the second prediction of items for which positive indication was received from the user; and
fine-tuning parameters of the machine-learned language model using the training dataset.

9. The method of claim 8, wherein receiving the positive indication from the user is for whether an item from the second prediction of items is in the receptacle comprises one of:
receiving an interaction with a positive user interface element presented to the user or receiving an indication of no interaction with a negative user interface element presented to the user,
wherein the parameters are fine-tuned according to the received interaction.

10. The method of claim 1, wherein the computer system is located on the receptacle.

11. The method of claim 1, wherein the computer system is remote from the receptacle.

12. The method of claim 1, wherein the extracted information includes one or more recommendation actions that cause the receptacle to automatically perform the one or more recommended actions,
wherein the one or more recommended actions comprise of illuminating one or more lights of the receptacle or locking of wheels of the receptacle in response to fraud detection.

13. A non-transitory computer readable storage medium comprising stored program code instructions, the instructions when executed causes a processing system to:
detect, by one or more sensors on a receptacle, receptacle sensor data describing a set of actions with respect to a set of items and the receptacle;
generate a first prediction of items from the set that are in a storage area of the receptacle from the receptacle sensor data;
generate a prompt for input to a machine-learned language model, the prompt specifying the first prediction, the receptacle sensor data, and a request for a prediction of items from the set that are in the storage area of receptacle;
receive, from the machine-learned language model, a response generated by executing the machine-learned language model on the prompt;
parse the response from the machine-learned language model to extract information identifying a second prediction of items from the set that are in the storage area of the receptacle; and
transmit instructions to an interface of the receptacle to cause a display of the second prediction of items on the interface of the receptacle.

14. The non-transitory computer readable storage medium of claim 13, wherein detecting the receptacle sensor data comprises detecting load measurements of the receptacle, images of bar codes of items added to the receptacle, and images of the items added to the receptacle.

15. The non-transitory computer readable storage medium of claim 13, wherein the instructions that cause the processing system to generate the first prediction of items comprise instructions that cause the processing system to:
receive, by a rule-based model, the receptacle sensor data;
compare, by the rule-based model, the receptacle sensor data to stored rules to determine the set of actions from the receptacle sensor data; and
identify items to include in the first prediction of items from the set of actions.

16. The non-transitory computer readable storage medium of claim 15, further storing instructions that cause the processing system to:
identifying, by the rule-based model, that a portion of the receptacle sensor data cannot be resolved into an action,
wherein the first prediction of items includes an indication regarding an uncertainty of an accuracy of the first prediction of items due to the portion of the receptacle sensor data not being resolved into the action.

17. The non-transitory computer readable storage medium of claim 16, wherein the portion of the receptacle sensor data is indicative of an item from the first prediction of items being moved from a first location within the receptacle to a second location in the receptacle.

18. The non-transitory computer readable storage medium of claim 16, wherein the prompt for input to the machine-learned language model is generated responsive to the indication regarding the uncertainty of the accuracy of the first prediction of items.

19. The non-transitory computer readable storage medium of claim 16, wherein the instructions that cause the processing system to parse the response comprises instructions that cause the processing system to:
extract the action that corresponds to the portion of the receptacle sensor data that could not be resolved by the rule-based model from the response of the machine-learned language model.

20. A computer system comprising:
a processor; and
a non-transitory computer-readable medium storing instructions that, when executed by the processor, cause the processor to:
detect, by one or more sensors on a receptacle, receptacle sensor data describing a set of actions with respect to a set of items and the receptacle;
generate a first prediction of items from the set that are in a storage area of the receptacle from the receptacle sensor data;
generate a prompt for input to a machine-learned language model, the prompt specifying the first prediction, the receptacle sensor data, and a request for a prediction of items from the set that are in the storage area of receptacle;
receive, from the machine-learned language model, a response generated by executing the machine-learned language model on the prompt;
parse the response from the machine-learned language model to extract information identifying a second prediction of items from the set that are in the storage area of the receptacle; and
transmit instructions to an interface of the receptacle to cause a display of the second prediction of items on the interface of the receptacle.
